(19) United States
(12) Patent Application Publication
(10) Pub. No.: US 2006/0236001 A1
(43) Pub. Date: Oct. 19, 2006

(54) Direct memory access controller

(75) Inventor: Jun Tanabe, Kawasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/190,184

(22) Filed: Jul. 27, 2005

(30) Foreign Application Priority Data
Apr. 14, 2005 (JP) 2005-117308

(51) Int. Cl. G06F 13/28

(52) U.S. Cl. 710/22

(57) ABSTRACT

a transfer control unit issues commands that the transfer data is divided into portions each having a prescribed transfer unit size. The portions of transfer data are sent separately to the device associated with the transfer destination address in such a manner that the final portion of the data to be transferred is transferred using a transfer method that requires a response from the device associated with the data transfer destination address. All other portions of the data to be transferred are transferred using a transfer method that does not require a response from the device associated with the data transfer destination.

### CROSS REFERENCE TO RELATED APPLICATIONS

This application is based upon and claims the benefit of priority from the prior Japanese Patent Application No. P2005-117308 filed on Apr. 14^{th}, 2005, the entire contents of which are incorporated herein by reference.

### BACKGROUND OF THE INVENTION

1. Field of the Invention

The present invention relates to a direct memory access controller and a system LSI including the direct memory access controller. More particularly, the present invention relates to a technology that can maintain the bus utilization efficiency during a data write transfer while also making it possible to ensure that the writing of the data to the transfer destination is completed.

2. Description of the Related Art

In recent years, attempts have been made to reduce the period of time required for the development of system LSI by using hierarchical design to promote parallel development and block reuse. When hierarchical design is employed, the system is often configured such that a plurality of function blocks (devices) is connected to a bus.

However, due to the advanced miniaturization of semiconductors, most of the total delay time of transmitted signals results from wiring delay and when data is transmitted through a bus having a large wiring length using the conventional method in which requests and responses are synchronized, the time during which the bus is occupied becomes long because the time required for signal transmissions over the bus is long. Consequently, the bus utilization efficiency declines and the performance of the system as a whole declines.

In view of this issue, Japanese Laid-open Patent Publication No. 2001-14281 (FIG. 2) discloses a technology that improves the bus utilization efficiency and the system performance by employing a bus interface is to use a split transaction method or other asynchronous method of handling requests for data transfers through the bus and responses to such requests that are transmitted through the bus.

The transfer efficiency of data transfers between devices has also been improved by using a direct memory access controller (DMAC) to transmit data without CPU intervention. Another technology for improving the transfer efficiency of data transfers is for executing read control and write control in a manner that is adjusted in accordance with fill level of a FIFO data buffer built into the DMAC (Design Wave Magazine, December 2003, pp. 39-57, CQ Publishing Co., Ltd.).

When the aforementioned bus interface is used and data write transfers are executed using the posted write method in which the transfer is completed with a write operation to a data buffer of the transfer destination via the bus interface and a handshake response to the write operation, the device from which the data is transferred (transfer origin device) can complete the transfer upon receiving the response from the bus. Although this approach improves the data transfer efficiency, it is not possible to know the timing at which the data write operation to the transfer destination device is actually completed.

Consequently, in situations where it is necessary to ensure the correctness of the data in the transfer destination device when the transfer origin device completes the transfer, the data write transfer can be executed, for example, using the non-posted write method, in which the data transfer is completed after a write complete signal is received from the transfer destination device. With the non-posted write method, however, the data transfer efficiency declines because the transfer origin device cannot start the next transfer until the write complete response is obtained from the transfer destination device.

Meanwhile, when a DMAC equipped with a FIFO data buffer is used, the data transfer efficiency is improved by executing read control and write control of data transfers made through the bus such the data is transferred with a single transfer or burst transfer, the read control and write control being adjusted based on the quantity of data stored in the FIFO data buffer. However, when data is transferred through a system bus configured such that the data buffer exists on the bus (a recent type of system bus), this technology cannot simultaneously achieve both the goal of improving the transfer efficiency and the goal ensuring that the data write operation is completed when the transfer origin device completes the data write transfer.

### SUMMARY OF THE INVENTION

An aspect of the present invention provides a direct memory access controller that includes an internal register arranged and configured to receive and store transfer information related to transfer data to be transferred, said transfer information including a data transfer origin address, a data transfer destination address, and information related to size of the transfer data, a transfer control unit arranged and configured to issue a transfer command, said transfer command for acquiring the transfer data from a device associated with the data transfer origin address based on the data transfer origin address and size of the transfer data stored in the internal register and sending the transfer data to a device associated with the data transfer destination address, a buffer arranged and configured to store the transfer data acquired in response to the transfer control unit, and an interface arranged and configured to receive the transfer data from the device associated with the data transfer origin address based on the transfer command, the interface arranged and configured to send the received transfer data to the device associated with the transfer destination address, wherein the transfer control unit issues commands such that the transfer data is divided into portions each having a prescribed transfer unit size, said portions of transfer data are sent separately to the device associated with the transfer destination address in such a manner that the final portion of the data to be transferred is transferred using a transfer method that requires a response from the device associated with the data transfer destination address and all other portions of the data to be transferred are transferred using a transfer method that does not require a response from the device associated with the data transfer destination.

Another aspect of the present invention provides a data transfer method employing a direct memory access controller that includes receiving transfer information related to a transfer data, said transfer information including a data transfer origin address, a data transfer destination address, and information related to the size of the data to be transferred, storing the transfer information, acquiring a portion of the transfer data, based the data transfer origin address and size of the transfer data, from a device associated with the data transfer origin address, said portion of the transfer data having a prescribed transfer unit size, storing acquired portion of transfer data, determining whether or not said portion of transfer data is the final portion of transfer data, and if said portion of transfer data is not the final portion of transfer data, transferring the portion of the transfer data to a device associated with the data transfer destination address using a transfer method that does not require a response from the device associated with the data transfer destination, if said portion of transfer data is the final portion of transfer data, transferring the portion of the transfer data to a device associated with the data transfer destination address using a transfer method that requires a response from the device associated with the data transfer destination address.

### BRIEF DESCRIPTION OF THE DRAWINGS

FIG. 1 is a schematic view of a system LSI that includes a direct memory access controller in accordance with an embodiment of the present invention.

FIG. 2 is a diagram for explaining the bus 300 of the embodiment.

FIG. 3 is a block diagram showing the constituent components of a direct memory access controller 200 in accordance with the present invention.

FIG. 4 is a schematic circuit diagram for explaining the direct memory access controller 200 of this embodiment.

FIG. 5 is a flowchart showing the data transfer method used by the direct memory access controller and shows the processing steps executed when the DMAC 200 transfers data from a device A to a device B.

FIG. 6 is a flowchart explaining the processing executed in step S200 of FIG. 5 in more detail.

FIG. 7 is a timing chart illustrating the write transfer processing that occurs during a posted write transfer.

FIG. 8 is a timing chart illustrating the write transfer processing that occurs during a non-posted write transfer.

### DETAILED DESCRIPTION OF THE EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

(System LSI Including Direct Memory Access Controller)

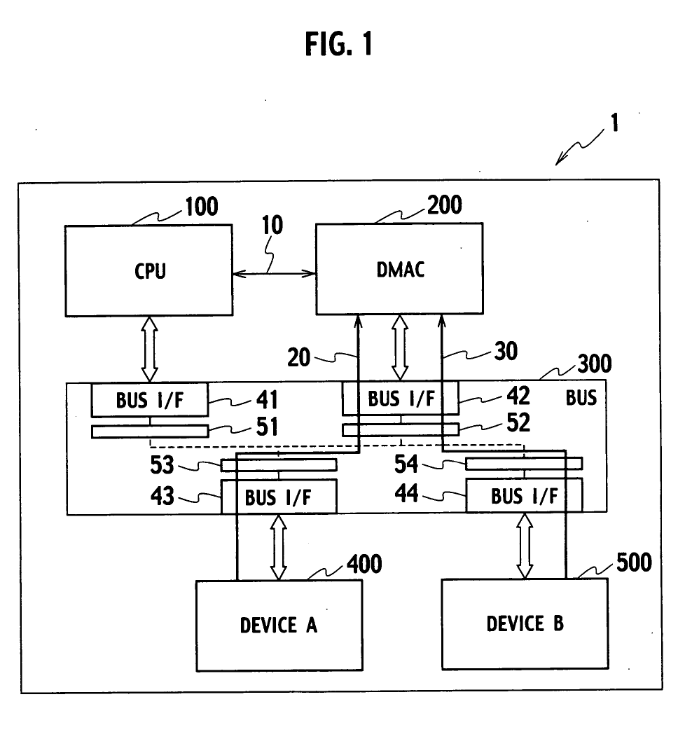

FIG. 1 is a schematic view of a system LSI that includes a direct memory access controller in accordance with an embodiment of the present invention. The system LSI 1 includes a direct access memory controller (DMAC) 200 that executes data transfer control when data transfers are made, a CPU 100 that executes various commands and instruct the DMAC 200 to execute data transfers, a bus 300 for transferring data between devices that are connected thereto, and devices 400, 500 that store various data.

A situation in which the CPU 100 issues a direct memory access request (DMA request) to the DMAC 200 will now be described. In this embodiment, when the CPU 100 issues a DMA request to the DMAC 200, the CPU 100 outputs transfer information that includes a DMA transfer start command, the address of the origin from which the transfer is to be made, the address of the transfer destination (target), and the size of the data to be transferred. The transfer information can be sent via the bus 300 or it can be sent directly to the DMAC 200 if a control line that connects the CPU 100 and DMAC 200 together directly is provided.

The DMAC 200 receives the transfer information and starts the DMA transfer process in accordance with the DMA transfer start command. First, the DMAC 200 identifies the device corresponding to the address of the transfer origin based on the address of the origin from which the transfer is to be made contained in the transfer information. Then the DMAC 200 identifies the device associated with the address of the transfer destination based on the address of the transfer destination contained in the transfer information. In this embodiment, it is assumed that a device A (400) is identified as the device associated with the address of the transfer origin and a device B (500) is identified as the device associated with the address of the transfer destination. Through the bus 300, the DMAC 200 acquires (arrow 20) data whose size equals the size of the data to be transferred and whose location starts with the prescribed address (address A) of the device A and writes the acquired data to a memory region that starts with the prescribed address (address B) of the device B. When the write operation ends, the DMAC 200 sends a data forward complete signal to the CPU 100. The data forward complete signal can be sent via the bus 300 or it can be sent directly to the CPU 100 if a control line 10 that connects the CPU 100 and DMAC 200 together directly is provided.

The devices A and B are storage devices that store data and examples include such memory devices as a ROM (Read Only Memory) or a RAM (Random Access Memory) and hard disk drives. In a case where the bus 300 is connected to a bridge and a memory device is accessed through the bridge, the bridge can also be treated as a one of the devices A or B.

The bus 300 has bus interfaces 41, 42, 43, 44 that serve as interfaces for the CPU 100, the DMAC 200, and the devices A and B. In this embodiment, the bus 300 has a pipeline structure and pipeline registers 51, 52, 53, 54 are provided inside the bus 300. Flip-flops, for example, can be used as the pipeline registers. Since the bus 300 has a pipeline structure, the devices connected to the bus 300 are connected together through the pipeline registers. When data is transferred, data stored in the pipeline registers is transferred from one pipeline register to the next once per cycle time (clock count) and finally arrives at the target device. In short, it normally takes several cycles to transfer the data to the target device through the bus 300.

For example, when the DMAC 200 reads data from the device A, the bus interface 42 receives a read command from the DMAC 200 and communicates with the bus interface 43. This communication takes place via the pipeline registers 52, 53. The bus interface 43 receives the prescribed data from the device A and transmits the data to the bus interface 42 through the pipeline registers 52, 53 inside the bus 300. The bus interface 42 then transmits the prescribed data to the DMAC 200.

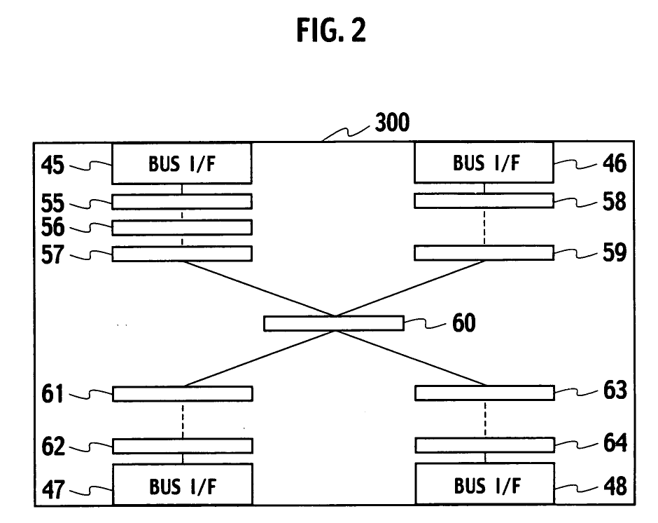

FIG. 2 is a diagram for explaining the bus 300 of this embodiment. As previously mentioned, the bus 300 of this embodiment has a pipeline structure and the bus interfaces 45, 46, 47, 48 can transfer data through the pipeline registers 55, 56, 57, 58, 59, 60, 61, 62, 63, and 64. For example, when data is transferred between the bus interface 45 and the bus interface 48, the data is transferred through the pipeline registers 55, 56, 57, 60, 63, and 64.

Limitations on the size of data buffer that can be built into the DMAC 200 and burst mode transfers with high transfer efficiencies used as DMA data transfers can cause the system bus to become continuously occupied with accesses from one device such that other devices cannot access the system bus for a particular period of time. In order to avoid this kind of situation, it is acceptable to establish an upper limit to the number of consecutive transfers that can be made using the burst transfer mode or otherwise establish a maximum value for transfer unit size used during data transfers.

In such a case, the data to be transferred can be divided and the resulting portions transferred separately. Assuming the first portion of the divided data is sent from the bus interface 45, said first portion of data will arrive at the bus interface 48 after a number of clock counts corresponding to the number of pipeline registers between the two bus interfaces and the subsequent portions of the divided data (whose number corresponds to the number of portions into which the data was divided) will be transmitted in sequence thereafter.

(Direct Memory Access Controller)

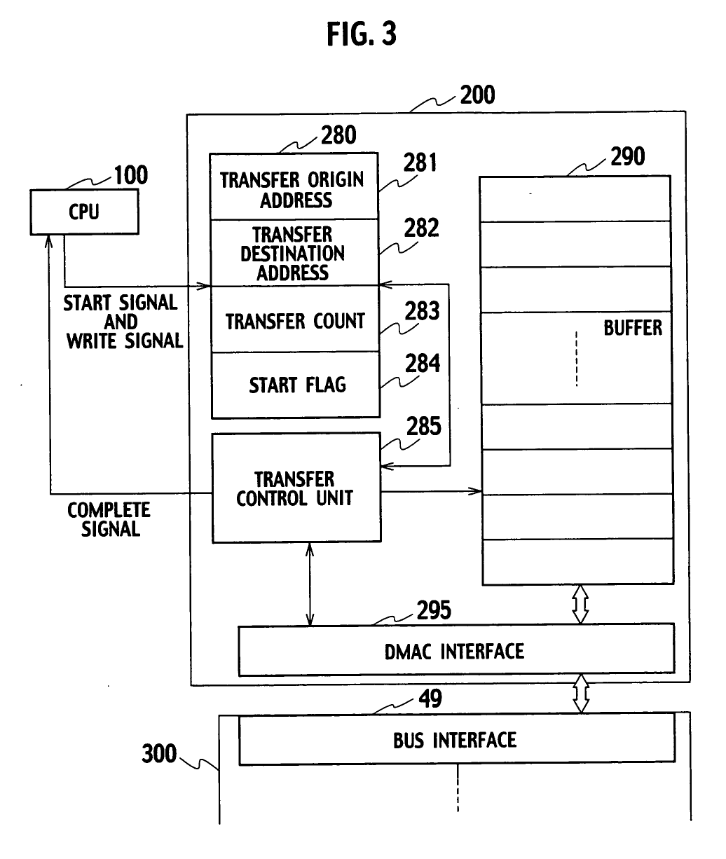

FIG. 3 is a block diagram showing the constituent components of a direct memory access controller 200 in accordance with the present embodiment. The direct memory access controller 200 comprises the following: a register 280 that receives transfer information and a start signal from the CPU 100 and store the transfer information and start signal; a transfer control unit 285 that starts data transfer processing based on the start flag stored in the register 280, execute data transfer processing based on the transfer information stored in the register 280, and send a completion signal to the CPU 100 when the data transfer processing is completed; a buffer 290 that temporarily stores data associated with the data transfer processing executed by the transfer control unit 285; and a DMAC interface 295 that is electrically connected to the buffer 290 and a bus interface of the bus 300 and receives data from a prescribed device based on a transfer command from the transfer control unit 285, send the received data to the buffer 290, and send the received data to a prescribed device. The register 280 has the following: a transfer origin address storage unit 281 that stores the transfer origin address contained in the transfer information; a transfer destination address storage unit 282 that stores the address of the transfer destination; a transfer count storage unit 283 that stores the number of transfers that will occur when the data is transferred; and a start flag storage unit 284 that stores the information indicating whether or not the start signal has been received.

The operation of the DMAC 200 will now be described. First, the DMAC 200 receives a start signal and a write signal from the CPU 100. These signals can be transmitted consecutively (one right after the other) or such that first the write signal is received and then the start signal is received later. In this embodiment, the write signal contains the transfer information. The transfer information comprises the address of the origin of the data that is to be transferred, the address of the destination to which the data is to be transferred, and the size of the data to be transferred. The transfer origin address is stored in the transfer origin address storage unit 281 and the transfer destination address is stored in the transfer destination address storage unit 282. The size of the data to be transferred is stored in the transfer count storage unit 283.

The transfer control unit 285 starts the data transfer processing when it detects the start signal. One feasible method of detecting the start signal is to continuously monitor the start flag storage unit 284 on a periodic (cyclical) basis and another method is to arrange for the transfer control unit 285 to receive the start signal directly from the CPU 100. In the latter case, it is not necessary to provide a start flag storage unit 284 in order to work the embodiment. After detecting the start signal, the transfer control unit 285 reads in the transfer origin address stored in the transfer origin address storage unit 281, the transfer destination address stored in the transfer destination address storage unit 282, and the number of transfers stored in the transfer count storage unit 283. Based on the transfer origin address, the transfer control unit 285 identifies the device (not shown) in which the data to be transferred is stored and issues a command instructing the DMAC interface 295 to read the data to be transferred. Upon receiving the command, the DMAC interface 295 issues a data transfer request to the bus interface 49 of the bus 300. The bus interface 49 acquires the specified data from the specified device (not shown) through the pipeline registers (not shown) inside the bus 300 and transfers the data to the DMAC interface 295. The DMAC interface 295 receives the data and sends it to the buffer 290 and the buffer 290 temporarily stores the data. The processing executed up to this point is called “read transfer processing.”

Next, based on the transfer destination address stored in the transfer destination address storage unit 282, the transfer control unit 285 identifies the device in which the data to be transferred is stored and issues a command instructing the DMAC interface 295 to read the data to be transferred. Upon receiving the command, the DMAC interface 295 issues a data transfer request to the bus interface 49 of the bus 300. The bus interface 49 sends the data stored in the buffer 290 to the identified device (not shown) through the pipeline registers (not shown) inside the bus 300.

When the data is transferred by dividing the data into portions, the process of reading data from the device in which the data to be transferred is stored and writing data to the transfer destination device is repeated a prescribed number of times in order to accomplish the reading and writing of all of the data to be transferred.

When the transfer ends, the transfer control unit 285 receives a complete signal from the transfer destination device through the DMAC interface 295. When the transfer control unit 285 receives the complete signal, it sends a complete signal to the CPU 100 in order to report that the data transfer has been completed and ends the transfer processing. The processing used to transfer data to the transfer destination device is called “write transfer processing.”

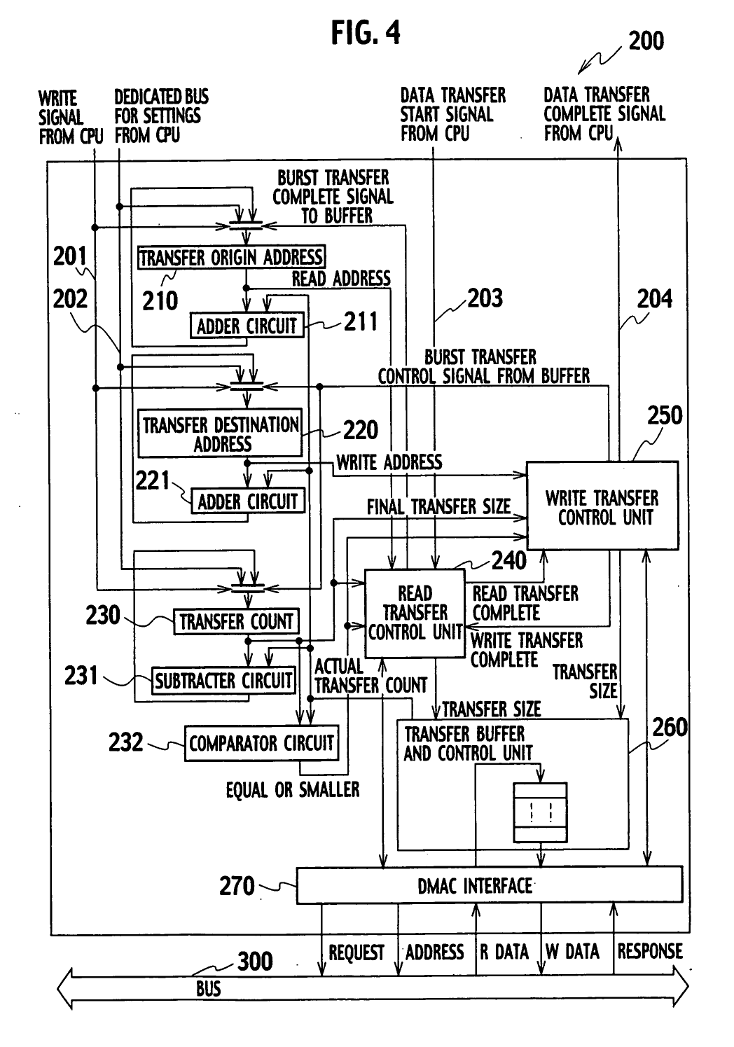

FIG. 4 is a schematic circuit diagram for explaining the direct memory access controller 200 of this embodiment. The DMAC 200 receives the transfer origin address (address A), the transfer destination address (address B), and the transfer count (1 K) from the CPU 100 through a register selection and write signal 201 from the CPU 100 and a dedicated bus 202 for settings from the CPU 100 and said transfer destination address (address A), transfer origin address (address B), and transfer count (1 K) are inputted/set into the transfer origin address register 210, transfer destination address register 220, and transfer count register 230, respectively. Then, when a data transfer start signal 203 is received from the CPU 100, data transfer commences in sets of one data read transfer and one data write transfer.

A comparator circuit 232 compares the value of the transfer count register 230 and the value of the transfer unit size and determines if the value of the transfer count register 230 is equal to or less than the value of the transfer unit size. In this embodiment the transfer unit size is 16 words. However, a direct memory access controller in accordance with the present embodiment is not limited to a transfer unit size of 16 words and the embodiment can be worked using other transfer unit sizes. If the value stored in the transfer count register 230 is determined to be larger than the value of the transfer unit size, a read transfer control unit 240 sends the output value (address A) of the transfer origin address register 210 and a read command serving as a bus operation request to a DMAC interface 270. The DMAC interface 270 reads sixteen words (in accordance with the transfer unit size) of the data starting with the address A from the device A by executing control in accordance with the interface protocol of the bus 300 at a timing (not shown) in accordance with the same. The DMAC interface 270 receives read data from the bus 300 and writes the read data to a FIFO data buffer inside a transfer buffer and control unit 260.

When the data read transfer ends, the read transfer control unit 240 uses an adder circuit 211 to add the value of the transfer unit size outputted from the transfer buffer and control block 260 to the content of the transfer origin register 210. A write transfer control unit 250 then sends the output value (address B) of the transfer destination address register 220 to the DMAC interface 270 along with a command serving as a bus operation request instructing the interface to use a data transfer method that does not request a response from the write destination device because this data write transfer does not contain the final transfer unit. In this embodiment, said command is a posted write command. Simultaneously, the data read from data buffer of the transfer buffer and control unit 260 is sent to the DMAC interface 270. On the other hand, if the data write transfer will be a transfer of the final transfer unit, the command issued to the DMAC interface 270 as a bus operation request will instruct the interface to use a data transfer method that requests a response from the write destination device. In this embodiment, said command sent to the DMAC interface 270 is a non-posted write command.

Data transfers using the posted write and non-posted write methods will be now explained. A posted write transfer is a data transfer in which the write destination device is not required to issue a response and is in accordance with the 1.0 version of the OCP (Open Core Protocol) specification promoted by OCP-IP (Open Core Protocol International Partnership) as a common standard. Meanwhile, a non-posted write transfer is a data transfer in which the write destination device is required to issue a response and is in accordance with the 2.0 version of the OCP specification.

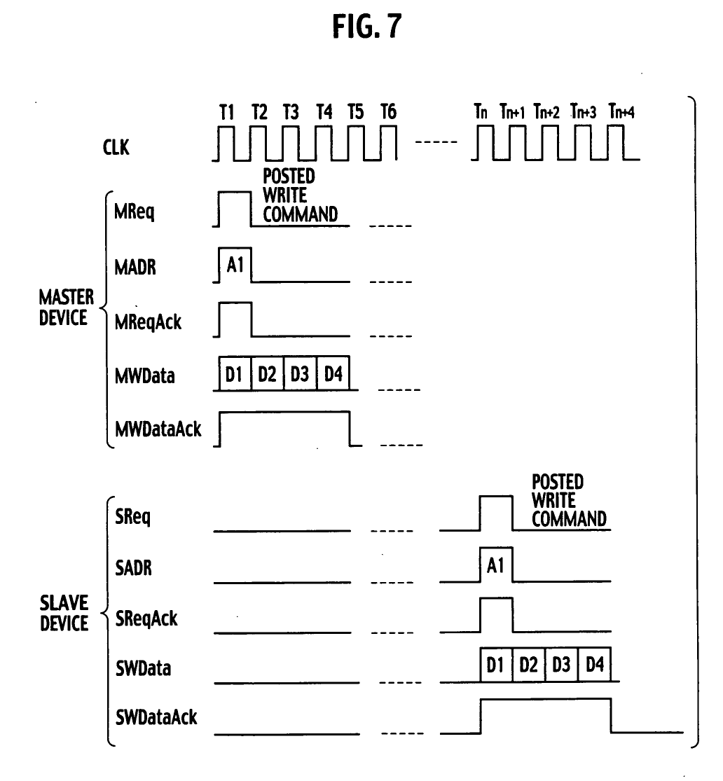

FIG. 7 is a timing chart illustrating the write transfer processing that occurs during a posted write transfer. During the cycle T1, the DMAC interface 270 sends a posted write command to the master bus request (MReq) signal line, receives a handshake signal (MReqAck) as a response from the bus 300, and sends the address B and the data read from the data buffer to the master address (MADR) signal line and the master write data (MWData) signal line (indicated as A1 and D1 in the figure), respectively. The DMAC interface 270 receives the write data handshake signal (MWDataAck) as a response and during the cycles T2, T3, and T4 consecutively outputs the data read from the data buffer as write data, thereby accomplishing a burst transfer.

In a posted write transfer, the processing ends at the point in time when the data is written to the buffer of the write destination (which exists on the bus 300 in this embodiment). Consequently, an explanation of the operation of the bus interface of the slave device is omitted here. The DMAC 200 can begin a new bus operation request during the cycle T5 or a later cycle.

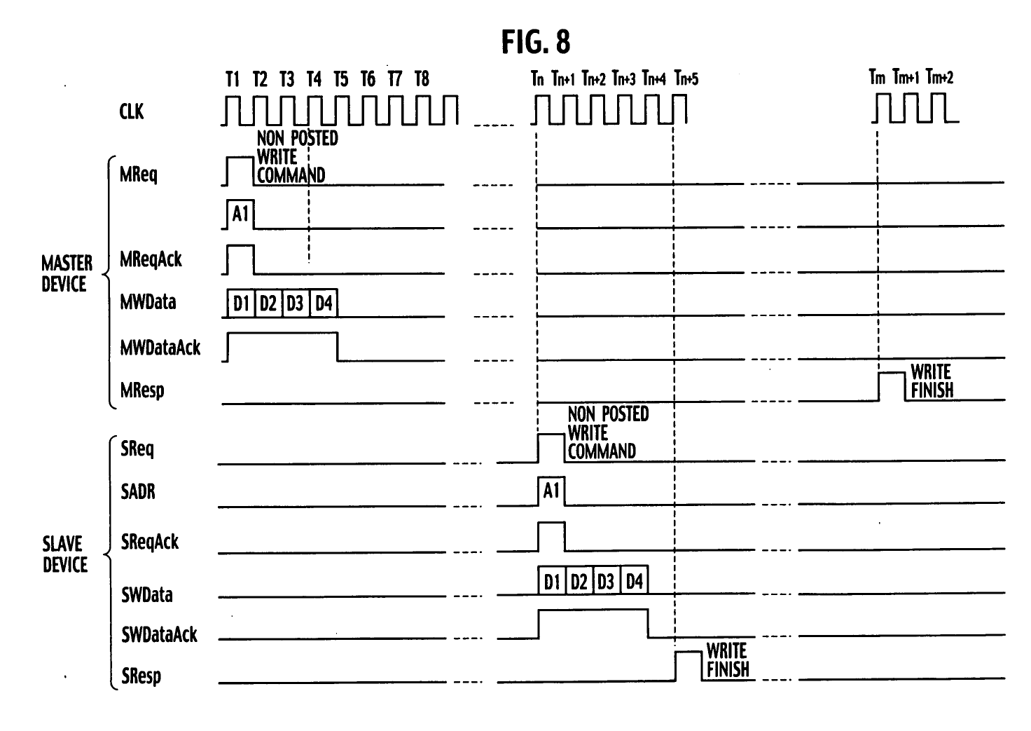

FIG. 8 is a timing chart illustrating the write transfer processing that occurs during a non-posted write transfer. During the cycle T1, the DMAC interface 270 sends a non-posted write command to the master bus request (MReq) signal line, receives a handshake signal (MReqAck) as a response from the bus 300, and sends the address B and the data read from the buffer 260 to the master address (MADR) signal line and the master write data (MWData) signal line (indicated as A1 and D1 in the figure), respectively. The DMAC interface 270 receives the write data handshake signal (MWDataAck) as a response and during the cycles T2, T3, and T4 consecutively outputs the data read from the data buffer as write data, thereby accomplishing a burst transfer.

Although the timing charts of FIGS. 7 and 8 show the data transfer being ended after four cycles, this is done merely for the sake of brevity in the figures. When the transfer unit size is 16, the data is outputted for 16 consecutive cycles via W data line (shown in FIG. 4) of the bus 300.

In a non-posted write transfer, the data write transfer does not end until the bus interface obtains a write end conformation response from the slave device. The operations with respect to the slave device will now be described.

During the cycle Tn (the delay time required for the signal to travel from the DMAC on the bus 300 to the device B is N−1 cycles), the bus interface of the slave device (device B) receives a non-posted write command and the address A1 from the bus 300 through the slave bus request (SReq) signal line and the slave address (SADR) signal line and outputs a request response signal (SReqAck). Upon receiving the request response signal, the bus 300 outputs the slave write data (SWData). The bus interface of the device B outputs the write data handshake signal (SWDataAck) as a response during the period when the device B can receive the data. In this embodiment, the write data is received by the bus interface of the device B during the consecutive cycles Tn+1, Tn+2, and Tn+3.

In this embodiment, the writing of the data to the specified address of the device B from the bus interface of the device B is actually completed two cycles later. Thus, the bus interface of the device B issues a slave response single (SResp) indicating that the write operation has been completed to the bus 300 during the cycle Tn+5.

At the cycle Tm, which corresponds to the delay time (three cycles) required for the signal to travel from the device B to the DMAC through the bus 300, the DMAC interface 270 of the DMAC receives the master response signal (MResp) indicating that the write operation at the device B has ended. Then, the DMAC interface 270 informs the write transfer control unit 250 that the data write transfer has ended.

When the DMAC 200 has completed the data write transfer of an amount of data equal to the transfer unit size, the write transfer control unit 250 uses an adder circuit 221 to add the value of the transfer unit size to the content of the transfer destination address register 220 and uses a subtracter circuit 231 to subtract the value of the transfer unit size from the content of the transfer count register 230. Next, the write transfer control unit 250 uses a comparator circuit 232 to compare the value of the transfer unit size to the value of the transfer count register 230. If the value of the transfer count register 230 is equal to or smaller than the value of the transfer unit size, the DMAC 200 executes final transfer unit size processing. Hereinafter, this value of the transfer count register 230 is called “the transfer count at the final transfer.”

The read transfer control unit 240 sends the value of the transfer origin address register 210 and a read command serving as a bus operation request to the DMAC interface 270 and sends the value of the transfer count register 230 to the transfer buffer and control unit 260. In conjunction with the transfer unit size and control unit 260, the DMAC 270 executes control in accordance with the interface protocol of the bus 300 at a timing (not shown) in accordance with the same so as to accomplish the following: read a quantity of the data starting with the address A from the device A, said quantity equaling the value of the transfer count register 230 (which corresponds to the transfer count at the final transfer); and write the data read from the device A to the data buffer inside the transfer buffer and control unit 260 via R data line (shown in FIG. 4) of the bus 300. When the data read transfer is ended, the read transfer control unit 240 uses the adder circuit 211 to add the value of the actual transfer count outputted from the transfer buffer and control block 260 to the content of the transfer origin register 210.

Next, in addition to sending the value of the transfer destination address register 220, the write transfer control unit 250 sends a non-posted write command to the DMAC interface 270 as a bus operation request because this data write transfer will be the transfer of the final block. Simultaneously, the write transfer control unit 250 sends data read from the buffer of the transfer buffer and control unit 260 to the DMAC interface 270.

The write transfer control unit 250 uses the adder circuit 221 to add actual transfer count to the value of the transfer destination address register 220 and uses the subtracter circuit 231 to subtract the actual transfer count from the value of the transfer count register 230. Meanwhile, the write transfer control unit 250 also sends the data transfer complete signal 204 to the CPU 100 in order to inform the CPU 100 that the data transfer has been completed.

Thus, with a direct memory access controller in accordance with this embodiment, posted write transfers (which do not require a write complete signal (response) from the device) can be used for the data write transfers of all transfer blocks except the final transfer block and a non-posted write transfer (which requires a write complete signal (response) from the device) can be used for the data write transfer of the final transfer block. As a result, a system can be provided in which approximately the same transfer efficiency is obtained as in a case where the posted write transfer is used exclusively and, at the same time, the completion of all the data write operations to the data transfer destination region can be ensured when the DMA request complete notification is issued to the CPU.

Although the data buffer mentioned in the preceding explanation is a FIFO buffer, the embodiment is not limited to using a FIFO buffer. Any data buffer is acceptable so long as it can be controlled such that data can be written to and read from any desired location in any desired order. For example, it is also feasible for the DMAC to substitute data arrays as it transfers the data.

(Data Transfer Method Utilizing the Direct Memory Access Controller)

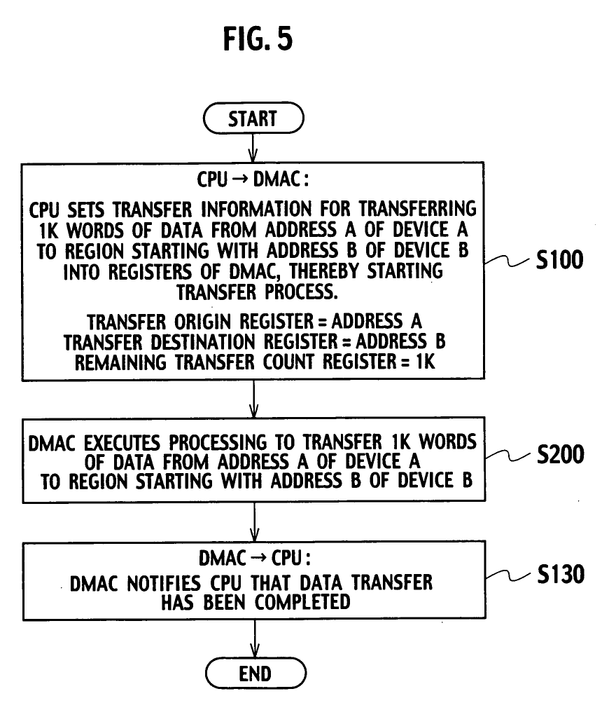

FIG. 5 is a flowchart showing the data transfer method used by the direct memory access controller and shows the processing steps executed when the DMAC 200 transfers data from a device A to a device B. First, the CPU 100 sends transfer information to a register of the DMAC 200, the transfer information being for transferring 1 K words of data from the address A of a device A to a region of a device B that starts with the address B, thereby starting a transfer operation (step S100). Next, the DMAC 200 executes the processing for transferring the 1 K words of data from the address A of the device A to the region of the device B that starts with the address B (step S200). This processing basically involves reading data from the device A starting with the address A and writing the data to a region of the device B that starts with the address B. When the data transfer has been completed, the DMAC 200 notifies the CPU 100 that the data transfer has ended (step S130).

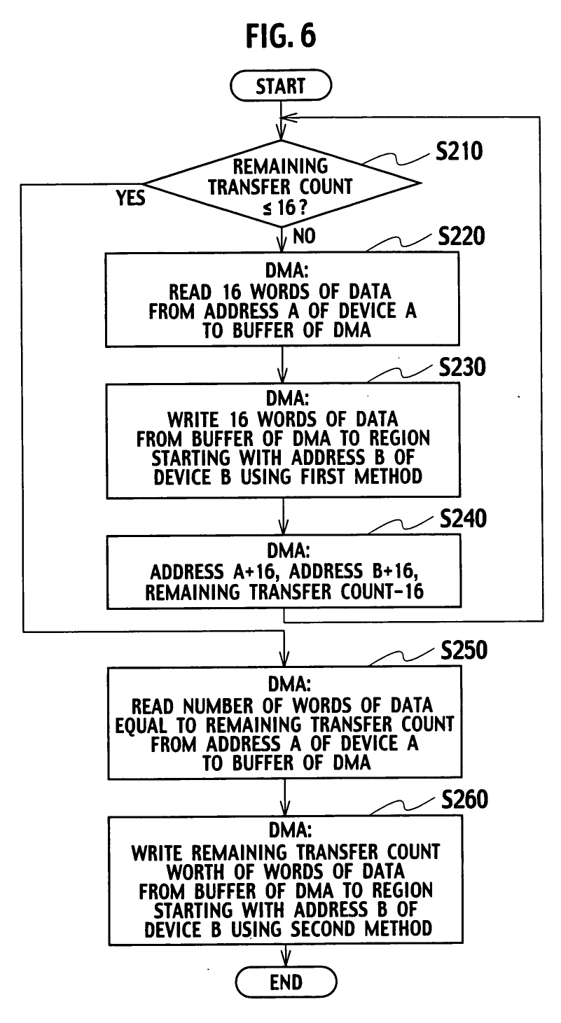

FIG. 6 is a flowchart explaining the processing executed in step S200 of FIG. 5 in more detail. Since the transfer count of the DMA request issued from the CPU is normally larger than the transfer count of the transfer unit size, the data transfer executed in response to the DMA request from the CPU is divided into a plurality of portions, i.e. separate transfers.

In the flowchart of FIG. 6, the data transfer unit size is 16. First, the DMAC 200 determines if the number of data transfers that remain in order to transfer the data (remaining transfer count) is equal to or less than a prescribed number (step S210). In this embodiment, the DMAC 200 determines if the remaining transfer count is equal to or smaller than 16 because the data transfer unit size is 16. In other words, this step determines if the remaining data to be transferred is the last data to be transferred. If the data is not the last data to be transferred, the DMAC 200 reads 16 words of data from the address of the device A into the buffer 290 (step S220). Next, the DMAC 200 writes the 16 words of data temporarily stored in the buffer 290 to the region of the device B that starts with the address B using a first method (step S230). In this embodiment, the first method can be the posted write transfer method, which does not require a response from the write destination. Next, the DMAC 200 uses the adder circuit 211 to add the value of the transfer unit size to the value of the transfer origin address register 210 where the transfer origin address is stored and stores the resulting sum in the transfer origin address register 210. Also, the DMAC 200 uses the adder circuit 221 to add the value of the transfer unit size to the value of the transfer destination address register 220 where the transfer destination address is stored and stores the resulting sum in the transfer destination address register 220. Additionally, the DMAC 200 uses the subtracter circuit 231 to subtract the value of the transfer unit size from the value of the transfer count register 230 where the transfer count is stored and stores the resulting difference in the transfer count register 230. After these operations are completed, the DMAC 200 makes the determination of step S210.

In this way, by executing the processing of steps S210 to S240, the DMAC 200 reads a quantity of data equal to the transfer unit size from the device A and copies the same data to the device B. These steps are executed repeatedly until the remaining transfer count is equal to or less than the transfer unit size. When the remaining transfer count is equal to or less than the transfer unit size, DMAC 200 reads the remaining data (whose size is equal to the remaining transfer count) from the address A of the device A into the buffer 290 (step S250) and writes the same data from the buffer 290 to the region of the device B that starts with the address B using a second method (step S260). In this embodiment, the second method can be a non-posted write transfer method, which requires a response from the write destination.

Thus, all transfer blocks except for the final transfer block are transferred using a transfer method that does not require a response during the write transfer and only the final transfer data block is transferred using a method that does require a response during the write transfer. As a result, approximately the same transfer efficiency is obtained as in a case where a transfer method not requiring a response is used exclusively and the completion of all the data write operations to the data transfer destination region can be ensured when the DMA request complete notification is issued to the CPU.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

What is claimed is:

1. A direct memory access controller, comprising:
an internal register arranged and configured to receive and store transfer information related to transfer data to be transferred, said transfer information including a data transfer origin address, a data transfer destination address, and information related to size of the transfer data;
a transfer control unit arranged and configured to issue a transfer command, said transfer command for acquiring the transfer data from a device associated with the data transfer origin address based on the data transfer origin address and size of the transfer data stored in the internal register and sending the transfer data to a device associated with the data transfer destination address;
a buffer arranged and configured to store the transfer data acquired in response to the transfer control unit; and
an interface arranged and configured to receive the transfer data from the device associated with the data transfer origin address based on the transfer command, the interface arranged and configured to send the received transfer data to the device associated with the transfer destination address,
wherein the transfer control unit issues commands such that the transfer data is divided into portions each having a prescribed transfer unit size, said portions of transfer data are sent separately to the device associated with the transfer destination address in such a manner that the final portion of the data to be transferred is transferred using a transfer method that requires a response from the device associated with the data transfer destination address and all other portions of the data to be transferred are transferred using a transfer method that does not require a response from the device associated with the data transfer destination.

2. The controller of claim 1, wherein the internal register comprises:
a data transfer origin address storage unit arranged and configured to store the address of the data transfer origin from which data is to be transferred;
a data transfer destination address storage unit arranged and configured to store the address of the data transfer destination to which data is to be transferred; and
a transfer count storage unit arranged and configured to store the size of the data to be transferred.

3. The controller of claim 2, wherein the internal register further comprises a start flag storage unit arranged and configured to store information indicating whether or not the start signal is received.

4. The controller of claim 2, wherein
the transfer control unit is configured such that:
each time a portion of the data to be transferred is transferred, the transfer control unit adds the transfer unit size to the address stored in the data transfer origin address storage unit, adds the transfer unit size to the address stored in the data transfer destination address storage unit, and subtracts the transfer unit size from the size of data stored in the transfer count storage unit; and
when the data size stored in the transfer count storage unit is equal to or less than the transfer unit size, the transfer control unit issues a command for transferring the final portion of the data to be transferred using a transfer method that requires a response from the device associated with the data transfer destination address.

5. The controller of claim 2, wherein the transfer control unit is configured to issue commands such that:
a portion of the transfer data having the prescribed transfer unit size is transferred to the buffer from the device associated with the address stored in the data transfer origin address storage unit;
said portion of the transfer data having the prescribed transfer unit size is transferred from the buffer to the device associated with the address stored in the data transfer destination address storage unit using a transfer method that does not require a response from the device associated with the data transfer destination address;
the transfer unit size is added to the address stored in the data transfer origin address storage unit and the resulting sum is stored in the data transfer origin address storage unit, the transfer unit size is added to the address stored in the data transfer destination address storage unit and the resulting sum is stored in the data transfer destination address storage unit, and the transfer unit size is subtracted from the size of data stored in the transfer count storage unit and the resulting difference is stored in the transfer count storage unit;
a determination is made as to whether or not the value stored in the transfer count storage unit is equal to or less than the transfer unit size and, if the determination result indicates that the content stored in the transfer count storage unit is equal to or less than the transfer unit size, a portion of the transfer data having a size equal to the data size stored in the transfer count storage unit is transferred to the buffer from the device associated with the address stored in the data transfer origin address storage unit; and
said portion of the transfer data having a size equal to the data size stored in the transfer count storage unit is transferred from the buffer to the device associated with the address stored in the data transfer destination address storage unit using a transfer method that requires a response from the device associated with the data transfer destination address.

6. A system LSI including a direct memory access controller, comprising
a direct memory access controller arranged and configured to execute data transfer control when data transfers are made;
a CPU arranged and configured to execute various commands and instruct the direct memory access controller to execute data transfers;
a plurality of devices arranged and configured to store various data; and
a bus for transferring data between devices that are connected thereto,
the direct memory access controller comprising:
an internal register arranged and configured to receive and store transfer information related to transfer data to be transferred, said transfer information including a data transfer origin address, a data transfer destination address, and information related to size of the transfer data;
a transfer control unit arranged and configured to issue a transfer command, said transfer command for acquiring the transfer data from a device associated with the data transfer origin address via the bus based on the data transfer origin address and size of the transfer data stored in the internal register and sending the transfer data to a device associated with the data transfer destination address via the bus;
a buffer arranged and configured to store the transfer data acquired in response to the transfer control unit; and
an interface arranged and configured to receive the transfer data from the device associated with the data transfer origin address based on the received transfer command, the interface arranged and configured to send the received transfer data to the device associated with the transfer destination address,
wherein the transfer control unit issues commands such that the transfer data is divided into portions each having a prescribed transfer unit size and the portions of transfer data are sent separately to the device associated with the transfer destination address in such a manner that the final portion of the transfer data is transferred using a transfer method that requires a response from the device associated with the data transfer destination address and all other portions of the transfer data are transferred using a transfer method that does not require a response from the device associated with the data transfer destination, and the transfer control notifies the CPU that the transfer is complete when said response is received.

7. The system LSI of claim 6, wherein the bus comprises:
a first bus interface connected to the direct memory access controller;
a second interface connected to said devices;
a plurality of pipeline registers arranged and configured to connect the first interface and the second interface together and temporarily store transfer data,
wherein transfer data is transferred from the first interface to the second interface by moving the transfer data consecutively from one pipeline register to the next once per unit time.

8. The controller of claim 7, wherein the internal register comprises:
a data transfer origin address storage unit arranged and configured to store the address of the data transfer origin from which data is to be transferred;
a data transfer destination address storage unit arranged and configured to store the address of the data transfer destination to which data is to be transferred; and
a transfer count storage unit arranged and configured to store the size of the data to be transferred.

9. The controller of claim 8, wherein the internal register further comprises a start flag storage unit arranged and configured to store information indicating whether or not the start signal is received.

10. The controller of claim 8, wherein
the transfer control unit is configured such that:
each time a portion of the data to be transferred is transferred, the transfer control unit adds the transfer unit size to the address stored in the data transfer origin address storage unit, adds the transfer unit size to the address stored in the data transfer destination address storage unit, and subtracts the transfer unit size from the size of data stored in the transfer count storage unit; and
when the data size stored in the transfer count storage unit is equal to or less than the transfer unit size, the transfer control unit issues a command for transferring the final portion of the data to be transferred using a transfer method that requires a response from the device associated with the data transfer destination address.

11. The controller of claim 8, wherein the transfer control unit is configured to issue commands such that:
a portion of the transfer data having the prescribed transfer unit size is transferred to the buffer from the device associated with the address stored in the data transfer origin address storage unit;
said portion of the transfer data having the prescribed transfer unit size is transferred from the buffer to the device associated with the address stored in the data transfer destination address storage unit using a transfer method that does not require a response from the device associated with the data transfer destination address;
the transfer unit size is added to the address stored in the data transfer origin address storage unit and the resulting sum is stored in the data transfer origin address storage unit, the transfer unit size is added to the address stored in the data transfer destination address storage unit and the resulting sum is stored in the data transfer destination address storage unit, and the transfer unit size is subtracted from the size of data stored in the transfer count storage unit and the resulting difference is stored in the transfer count storage unit;
a determination is made as to whether or not the value stored in the transfer count storage unit is equal to or less than the transfer unit size and, if the determination result indicates that the content stored in the transfer count storage unit is equal to or less than the transfer unit size, a portion of the transfer data having a size equal to the data size stored in the transfer count storage unit is transferred to the buffer from the device associated with the address stored in the data transfer origin address storage unit; and
said portion of the transfer data having a size equal to the data size stored in the transfer count storage unit is transferred from the buffer to the device associated with the address stored in the data transfer destination address storage unit using a transfer method that requires a response from the device associated with the data transfer destination address.

12. A data transfer method employing a direct memory access controller, comprising:
receiving transfer information related to a transfer data, said transfer information including a data transfer origin address, a data transfer destination address, and information related to the size of the data to be transferred;
storing the transfer information;
acquiring a portion of the transfer data, based the data transfer origin address and size of the transfer data, from a device associated with the data transfer origin address, said portion of the transfer data having a prescribed transfer unit size;
storing acquired portion of transfer data;
determining whether or not said portion of transfer data is the final portion of transfer data; and
if said portion of transfer data is not the final portion of transfer data, transferring the portion of the transfer data to a device associated with the data transfer destination address using a transfer method that does not require a response from the device associated with the data transfer destination address,
if said portion of transfer data is the final portion of transfer data, transferring the portion of the transfer data to a device associated with the data transfer destination address using a transfer method that requires a response from the device associated with the data transfer destination address.

13. The method as claimed in claim 12, wherein the determining whether or not said portion of transfer data is the final portion of transfer data comprises:
each time a portion of the transfer data is transferred,
adding the prescribed transfer unit size to the stored data transfer origin address;
adding the prescribed transfer unit size to the data transfer destination address;
subtracting the prescribed transfer unit size from stored size of the transfer data; and
when the size of the data to be transferred is equal to or less than the prescribed transfer unit size, transferring the final portion of the data to be transferred using a transfer method that requires a response from the device associated with the data transfer destination address.
